(19) United States
(12) Patent Application Publication
(10) Pub. No.: US 2011/0041118 A1
(43) Pub. Date: Feb. 17, 2011

(54) MENU DRIVEN COMPONENT BASED BUILD SYSTEM

(75) Inventor: Robert Chun Wen, Redwood City, CA (US)

Correspondence Address: Trellis Intellectual Property Law Group, PC, 1900 EMBARCADERO ROAD, SUITE 109, PALO ALTO, CA, 94303, US

(73) Assignees: Sony Corporation, Tokyo (JP); Sony Electronics, Inc., Parkridge, NJ (US)

(21) Appl. No.: 12/539,502

(22) Filed: Aug. 11, 2009

(51) Int. Cl. G06F 9/44

(52) U.S. Cl. 717/120

(57) ABSTRACT

Particular embodiments generally relate to an implementation of a build engine. In one embodiment, a method for implementing a build engine includes receiving at least one menu that includes one or more sections, wherein each of the one or more sections indicates one or more libraries, and wherein each of the one or more libraries is associated with one or more software components. The method also includes parsing each of the one or more sections to determine the one or more libraries and the one or more software components. The method also includes building, by a computer processor, executable software code based on the one or more libraries and the one or more of the software components.

### BACKGROUND

Software build systems are used for the construction of software products. Some software build systems build software products that are designed based on a component architecture model. Commercially available or open source software build solutions generally provide mechanisms to address build rules, build output, and build commands. However, when it comes to component models, a growing number of components and release requirements present a much higher number of combination choices of components. Constructing rules for each component combination and dependencies among components is time consuming and significantly increases the complexity of a build system. Consequently, it takes more time and effort for developers, test engineers, and build engineers to sort out the steps to complete different build and release requirements.

### SUMMARY

Particular embodiments generally relate to an implementation of a build engine. In one embodiment, a method for implementing a build engine includes receiving at least one menu that includes one or more sections, wherein each of the one or more sections indicates one or more libraries, and wherein each of the one or more libraries is associated with one or more software components. The method also includes parsing each of the one or more sections to determine the one or more libraries and the one or more software components. The method also includes building, by a computer processor, executable software code based on the one or more libraries and the one or more of the software components.

A further understanding of the nature and the advantages of particular embodiments disclosed herein may be realized by reference of the remaining portions of the specification and the attached drawings.

### BRIEF DESCRIPTION OF THE DRAWINGS

FIG. 1 depicts a simplified system that may be used to implement a build engine, according to one embodiment.

FIG. 2 depicts a simplified block diagram of a computer system that may be used to implement a build engine, according to one embodiment.

FIG. 3 depicts a simplified build menu, according to one embodiment.

FIG. 4 depicts a simplified flowchart for implementing a build engine, according to one embodiment.

### DETAILED DESCRIPTION OF EMBODIMENTS

Embodiments described herein provide a menu driven component based build system for building software products that may be used by developers, test engineers, project managers, and other users. As described in more detail below, the build process is menu driven such that users are able to use build menus to select which software components are used to build executable software code.

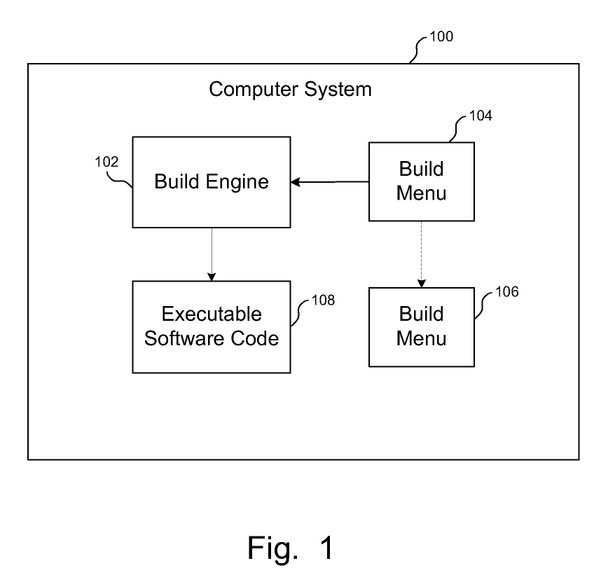

FIG. 1 depicts a simplified computer system 100 that may be used to implement a build engine, according to one embodiment. As FIG. 1 shows, in one embodiment, the computer system 100 includes a build engine 102 that receives or accesses one or more build menus 104 and 106. As described in more detail below, after a given user selects a build menu (e.g., build menu 104), the build engine 102 executes a build process in order to output executable software code 108 that may to be used by the user. As FIG. 1 shows, a given build menu (e.g., build menu 104) may reference or specify one or more other build menus (e.g., build menu 106). In one embodiment, where a primary build menu specifies one or more other menus, build engine 102 may ultimately parse multiple build menus (e.g., build menus 104 and 106). In one embodiment, if build menu 104 specifies a second build menu 106, the specified build menu 106 become a part of build menu 104 such that build engine receives or accesses only one build menu. In an alternative embodiment, if build menu 104 specifies a second build menu 106, the specified build menu 106 is referenced by build menu 104 such that build engine receives or access both build menus 104 and 106.

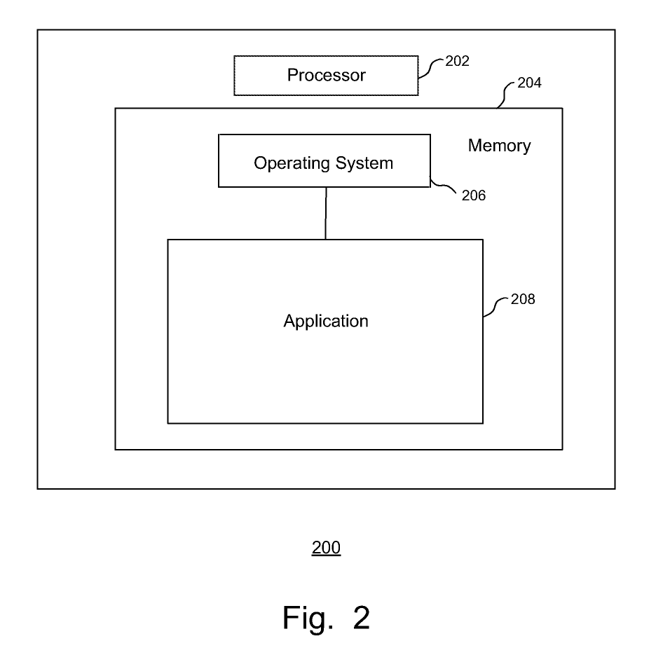

FIG. 2 depicts a simplified block diagram of a computer system 200 that may be used to implement a build engine, according to another one embodiment. As FIG. 2 shows, the computer system 200 includes a processor 202, a memory 204, an operating system 206, and an application 208. The application 208 is stored on any suitable storage location or computer-readable medium, such as memory 204. Application 208 provides instructions that enable processor 202 to perform the functions described herein, such as functions for implementing build engine 102 of FIG. 1. For example, in one embodiment, application 208 may employ a build driver and other software tools to drive the build process to construct executable software code.

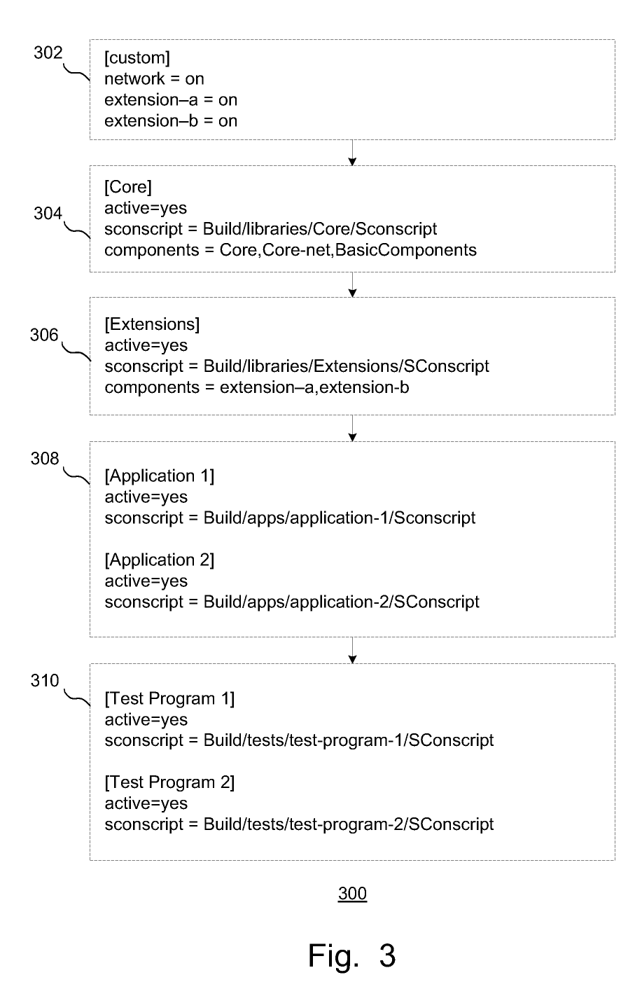

FIG. 3 depicts a simplified build menu 300, according to one embodiment. As FIG. 3 shows, in one embodiment, the build menu 300 includes several sections such as a custom section 302, a core section 304, an extensions section 306, one or more application sections 308, and one or more test program sections 310. As described in more detail below, the selected build menu (e.g., build menu 104) specifies a list of libraries to be built. These libraries constitute the final software products to be shipped. Each library consists of one of more software components. A given software component consists of one or more source files. These source files implement functionalities of a component.

In one embodiment, custom section 302 specifies customizable build engine options, which are indicated with keys: network, extension-a, and extension-b, the network key indicates a networking option, and extension-a and extension-b indicate extension features for the software product. In one embodiment, the key/value pair of “network=on” indicates that the build should include a networking option. In one embodiment, the key/value pair of “extension-a=on” indicates that an optional component that implements an extension feature represented by extension-a is to be built by build engine 102. In one embodiment, the key/value pair of “extension-b=on” indicates that an optional component that implements an extension feature represented by extension-b is to be built by build engine 102.

In one embodiment, core section 304 specifies core software components that get archived into a core library during the build process. In one embodiment, before the build process is executed, the software components are source files, and, during the build process, build engine 102 compiles the software components into object files in binary form and then archives the object files into the libraries. In one embodiment, core section 304 and an associated core library is required for all build requirements. In one embodiment, core section 304 includes a parse indicator (labeled “active”), a build script indicator (labeled “sconscript”), and a components indicator (labeled “components”). In one embodiment, parse indicator indicates if the given section (e.g., core section 304) should be parsed or not, the build script indicator points to the build script path, and a components indicator lists the software components that are to be included in the build. In a specific embodiment, the build scripts used are SConscripts. However, any suitable scripts may be used. Build engine 102 uses the build scripts pointed to by the build script path for handling compilation and for linking software components in the given section (e.g., core section 304). The build scripts may be derived from a template that standardizes the actual build operations. Developers, test engineers, and other users may draft build scripts based on this template.

In one embodiment, the key/value pair of “active=yes” indicates that this section is to be activated and parsed. Conversely, a key/value pair of “active=no” would indicate that this section is to be deactivated (e.g., not parsed). In one embodiment, the key/path “sconscript=Build/libraries/Core/SConscript” indicates a path to SConscripts in the core library. In one embodiment, the key/tuple “components=Core,Core-net,BasicComponents.” indicates the core software components that are to be included in the build.

In one embodiment, extensions section 306 specifies the extension software components that get archived into an extension library. The extension library is optional, depending upon build requirements for a given customer.

In one embodiment, the key/value pair of “active=yes” indicates that this section is to be activated and parsed. In one embodiment, the key/path “sconscript=Build/libraries/Core/SConscript” indicates a path to SConscripts in the extensions library. In one embodiment, the key/tuple “components=extension-a,extension-b” indicates the extension software components that are to be included in the build.

In one embodiment, in addition to core and extensions libraries, a given build menu may also include sections for constructing applications and test programs, which may be part of the executable software that build engine 102 outputs. For example, if the build requirements include an Application 1, an Application 2, a Test Program 1, a Test Program 2, corresponding application and test program sections 308 and 310 respectively may also be included, as shown in FIG. 3. Such applications and test programs are linked against the core and extensions libraries.

In one embodiment, these application and test program sections 308 and 310 may also include corresponding parse and build script indicators, similar to those described above. Similar to core and extensions libraries, the build scripts pointed to by the build script paths are standardized so that developers and test engineers can draft new ones quickly to be included in the build.

As the build script paths described above indicate, each library folder is associated with software components configuration (config) files. These config files may be named as “<component name>.cfg.” In particular embodiments, each config file describes component custom flags and source files.

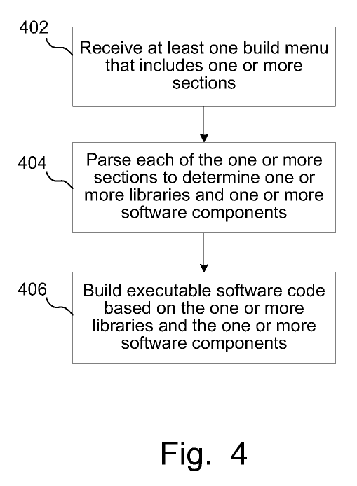

FIG. 4 depicts a simplified flowchart for implementing a build engine, according to one embodiment. In one embodiment, build engine 102 receives at least one menu that includes one or more sections (box 402). In one embodiment, build engine 102 may receive build menu 104 based on a user provided selection, which could be a build menu name or other input parameter. As indicated above, each of the one or more sections indicates one or more libraries, and each of the one or more libraries is associated with one or more software components. Build menu 104 may have the same or similar sections to those shown in FIG. 3.

As indicated above, with regard to FIG. 1, build menu 104 may specify one or more other build menus (e.g., build menu 106). As indicated above, each build menu references one or more libraries, where each library is associated with one or more software components, which consists of one or more source files. In one embodiment, if the selected build menu 104 specifies build menu 106, build menu 106 may have similar but different sections to those of build menu 104. In one embodiment, build menu 106 may optionally include a core section.

Build engine 102 then parses each of the one or more sections to determine the one or more libraries and the one or more software components (box 404). In one embodiment, where build menu 104 specifies build menu 106, build engine 102 ultimately parses multiple build menus (e.g., build menus 104 and 106).

Build engine 102 then builds executable software code based on the one or more libraries and the one or more of the software components according to the selected build menu 104 (and any other build menu that build menu 104 might specify) (box 406). In one embodiment, after build engine 102 parses the information presented in the one or more build menus, build engine 102 compiles the associated source code file in order to output object files. Build engine 102 then archives the object files into libraries, and the libraries become part of the final executable software code.

The following paragraphs describe various detailed embodiments related to the build menus described above, including adding and removing build folders, libraries, and associated files.

In one embodiment, a build folder stores all build scripts, source file list and build config files, and intermediate build artifacts (e.g., object files). The final build artifacts go into bin, release or debug.

In one embodiment, build scripts have a location free build script structure. In one embodiment, the build menu and associated component configuration files are independent of the location of the source code that is associated with the software components. The following is an example location free build script structure, in a specific embodiment:

```
<PROJECT>/Build
    cfg/ - global compiler and linker command options.
    menus/
          Includes build menus for various build requirements.
          Default build menus: default.PS3, default.posix, default.Win32
    libraries/
              Core/
                    scons script to build the Core library.
                    Component config files are for the Core library.
                    Each component config describes source files
                    that make up Core lib.
              Extensions/
                    scons script to build extensions library.
                    Currently, PS3 specific extensions are supported.
                    Component config files are for the Extensions
                    library. Each component config describes source
                    files that make up Extensions lib.
        Apps/
          Each subfolder contains build scripts and application config
          for an application.
          Similar to component config, the app config, named app.cfg
          describes source files required for this app.
    Tests/
      Each subfolder contains build scripts and application config for a
      unit test. Similar to component config, the app config, named
    app.cfg describes source files required for this test.
```

In one embodiment, a top level build driver loads a top level SConsscript (e.g., (SConstruct). The SConstruct reads a build menu for a supported platform (default build menus are default.PS3, default.posix and default.Win32.). In particular embodiments, a build menu defines which libraries, components and applications/tests to build. Also, customized compiler flags may be defined at menu, library, component or file levels. Also, selected components, custom compiler flags, selected target platform are all compatible with one another. For example, in one embodiment, if a NetworkSource component is selected, no-networking flags are not used. In one embodiment, if building on Win32, PS3 specific components are not selected. Also, in particular embodiments, all build menus, library and component config files may be written in Python ConfigParser format.

In one embodiment, while reading a build menu, if a section has “active=yes”, its corresponding SConscript is loaded. Also, each section describes build info for a library, an application, or a test program.

In one embodiment, to add or remove a given source file to compile, a user may identify the software component that is associated with the source file and then add/remove the build script path from the appropriate component config file. In one embodiment, the user may determine which supported platform this file supports. If all platforms are supported, the user may then add it to a section (e.g., [all]). Otherwise, the user may add it to the appropriate platform section (i.e., [PS3], [posix], or [Win32]).

In one embodiment, if the config file is written in ConfigParser format, the entry for a source file would be in the form of:

<path name relative to project source tree top>:1
Components/Configurator/Configurator.cpp:1

In this specific example, the number “1” simply indicates that this file is to be included for compilation. It can be excluded from compilation by setting to “0.” In an alternative embodiment, it also can be replaced by customized compiler flags.

In one embodiment, to invoke a build with the new menu, an “-m” flag may be used (e.g.<build-driver -m Build/menus/my-menu).

In one embodiment, each subfolder of a given build script path stores build info for a library to be shipped, and these build script paths may be associated with files such as library configuration (lib config) files (e.g., lib.cfg files). In one embodiment, lib.cfg defines custom build flags for the library. A library can be static or shared. In one embodiment, there is a configuration (config) file (e.g., <component name>.cfg) for each software component that can be part of a given library.

As indicated above, component config files are located under library subfolders (e.g., In <PROJECT>/Build/libraries/Core, there are Core.cfg and Core-net.cfg). A component config file defines component custom build flags and source files for this component. In one embodiment, custom build flags may be updated by updating the custom section. A source file list may be updated by updating platform sections accordingly, i.e. [all], [PS3], [posix], or [Win32].

In one embodiment, application config files (app.cfg) may reside in subfolders under <PROJECT>/Build/Apps, and test config files may reside in subfolders under <PROJECT>/Build/Tests. Sample config files may reside in subfolders under <PROJECT>/Build/Samples. In an app/test/sample folder, there exists a config file, named “app.cfg” (e.g., <PROJECT>/Build/Apps/test-app/app.cfg). Application config files may be updated for application custom build flags and source files.

In one embodiment, an application may be built with the following command format: build-driver -a <appname> where <appname> is a section defined for an app/test/sample in a build menu (e.g., build-driver -a LocalTest -m Build/menus/unittest.PS3; or build-driver -p posix -a LocalTest -m Build/menus/unittest.posix).

In one embodiment, custom compiler flags may be specified under the [custom] section in a build config file. Configurable flags may include the following: cflags (C/C++ compiler flags), incpath (include paths)—no need to use prefix, “-I,” libs (link libs)—no need to use prefix, “-1,” libpath (link lib paths)—no need to use prefix, “-L,” and linkflags (general linker flags). In one embodiment, syntax for specifying custom flags may include the following: add newflag1[newflag2 . . . ], replace oldflag newflag, remove oldflag1[oldflag2 . . . ]

The following are examples of customizing compiler/linker flags:

```
      Add -D_FOO -D_BAR -Wsome-warning default build
      menu for PS3:
          Open Build/menus/default.PS3.
          Enter “cflags: add -D_FOO -D_BAR -Wsome-warning”
in [custom] section.
      Replace -D_ABC -D_XYZ for Core library:
          Open Build/libraries/Core/lib.cfg.
          Enter “cflags: replace -D_ABC -D_XYZ” in [custom]
          section.
      Add /tmp/include <PROJECT>/some-include to include paths for
NetworkSources component:
          Open Build/libraries/Core/NetworkSources.cfg.
          Enter “incpaths: add /tmp/include some-include” in
          section [custom].
      Add mylib to link libs for Core lib:
          Open Build/libraries/Core/lib.cfg.
          Enter “libs: add mylib” in section [custom].
      Remove -Werror -D_XYZ from compiling Log.cpp:
          Open Build/libraries/Core/Core.cfg.
          Goto the line where Common/Log.cpp is located.
          Replace value “1” by “remove -Werror -D_XYZ.”
```

Although the description has been described with respect to particular embodiments thereof, these particular embodiments are merely illustrative, and not restrictive.

Any suitable programming language can be used to implement the routines of particular embodiments including C, C++, Java, assembly language, etc. Different programming techniques can be employed such as procedural or object-oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a,” “an,” and “the” include plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method for implementing a build engine, the method comprising:
receiving at least one menu that includes one or more sections, wherein each of the one or more sections indicates one or more libraries, and wherein each of the one or more libraries is associated with one or more software components;
parsing each of the one or more sections to determine the one or more libraries and the one or more software components; and
building, by a computer processor, executable software code based on the one or more libraries and the one or more of the software components.

2. The method of claim 1, wherein the one or more sections comprise a core section that indicates one or more core software components to be archived in a core library.

3. The method of claim 1, wherein the one or more sections comprise a core section that indicates one or more core software components to be archived in a core library, and wherein the core section comprises:
a parse indicator that indicates if the core section is to be parsed;
a script indicator that indicates a build script path; and
a components indicator that indicates one or more core software components to be archived in the core library.

4. The method of claim 1, wherein the one or more sections comprise at least one extension section that indicates one or more extension software components to be archived in an extension library.

5. The method of claim 1, wherein the one or more sections comprise at least one extension section, and wherein each of the extension sections comprises:
a parse indicator that indicates if the extension section is to be parsed;
a script indicator that indicates a build script path; and
a components indicator that indicates one or more extension software components to be archived in an extension library.

6. The method of claim 1, wherein the at least one menu indicates one or more additional menus to be parsed during the executable software code building step.

7. The method of claim 1, wherein the at least one menu and associated component configuration files are independent of a location of source code associated with the one or more software components.

8. An apparatus comprising:
one or more computer processors; and
logic encoded in one or more computer-readable storage media for execution by the one or more computer processors and when executed operable to:
receive at least one menu that includes one or more sections, wherein each of the one or more sections indicates one or more libraries, and wherein each of the one or more libraries is associated with one or more software components;
parse each of the one or more sections to determine the one or more libraries and the one or more software components; and
build executable software code based on the one or more libraries and the one or more of the software components.

9. The apparatus of claim 8, wherein the one or more sections comprise a core section that indicates one or more core software components to be archived in a core library.

10. The apparatus of claim 8, wherein the one or more sections comprise a core section that indicates one or more core software components to be archived in a core library, and wherein the core section comprises:
a parse indicator that indicates if the core section is to be parsed;
a script indicator that indicates a build script path; and
a components indicator that indicates one or more core software components to be archived in the core library.

11. The apparatus of claim 8, wherein the one or more sections comprise at least one extension section that indicates one or more extension software components to be archived in an extension library.

12. The apparatus of claim 8, wherein the one or more sections comprise at least one extension section, and wherein each of the extension sections comprises:
a parse indicator that indicates if the extension section is to be parsed;
a script indicator that indicates a build script path; and
a components indicator that indicates one or more extension software components to be archived in an extension library.

13. The apparatus of claim 8, wherein the at least one menu indicates one or more additional menus to be parsed during the executable software code building step.

14. The apparatus of claim 8, wherein the at least one menu and associated component configuration files are independent of a location of source code associated with the one or more software components.

15. A computer-readable storage medium including logic for execution by one or more computer processors and when executed operable to:
receive at least one menu that includes one or more sections, wherein each of the one or more sections indicates one or more libraries, and wherein each of the one or more libraries is associated with one or more software components;
parse each of the one or more sections to determine the one or more libraries and the one or more software components; and
build executable software code based on the one or more libraries and the one or more of the software components.

16. The computer-readable storage medium of claim 15, wherein the one or more sections comprise a core section that indicates one or more core software components to be archived in a core library.

17. The computer-readable storage medium of claim 15, wherein the one or more sections comprise a core section that indicates one or more core software components to be archived in a core library, and wherein the core section comprises:
a parse indicator that indicates if the core section is to be parsed;
a script indicator that indicates a build script path; and
a components indicator that indicates one or more core software components to be archived in the core library.

18. The computer-readable storage medium of claim 15, wherein the one or more sections comprise at least one extension section that indicates one or more extension software components to be archived in an extension library.

19. The computer-readable storage medium of claim 15, wherein one or more sections comprise at least one extension section, and wherein each of the extension sections comprises:
a parse indicator that indicates if the extension section is to be parsed;
a script indicator that indicates a build script path; and
a components indicator that indicates one or more extension software components to be archived in an extension library.

20. The computer-readable storage medium of claim 15, wherein the at least one menu indicates one or more additional menus to be parsed during the executable software code building step.
